(19) United States
(12) Patent Application Publication
(10) Pub. No.: US 2006/0242397 A1
(43) Pub. Date: Oct. 26, 2006

(54) Methods of resizing partition

(75) Inventors: Frode Chen, Chongqing (CN); Kin Huang, Chongqing (CN)

Correspondence Address: ARENT FOX PLLC, 1050 CONNECTICUT AVENUE, N.W., SUITE 400, WASHINGTON, DC, 20036, US

(73) Assignee: Far Stone Tech., Inc.

(21) Appl. No.: 11/404,096

(22) Filed: Apr. 14, 2006

(30) Foreign Application Priority Data
Apr. 14, 2005 (TW) 94111763

(51) Int. Cl. G06F 15/177

(52) U.S. Cl. 713/1

(57) ABSTRACT

A system and methodology that securely protects data in a partition of a computer system. According to the invention, the method of resizing a partition comprises the steps of: calculating data in the partition to be modified; replacing a MBR with a new MBR; loading the new MBR; and changing data in accordance with the calculated data.

### CROSS-REFERENCE TO RELATED APPLICATIONS

This is a 35 U.S.C. § 119 of Taiwan Application No. 94111763 filed Apr. 14, 2005. The disclosure of the prior application is hereby incorporated by reference herein in its entirety.

### BACKGROUND OF THE INVENTION

1. Field of the Invention

The present invention relates generally to manipulation of a partition, and more particularly to a method that resizes partition in a computer system.

2. Description of Prior Art

A hard disk can be divided into several logical drives, or partitions. Typically most PCs (personal computer) today arrive with the hard disk already partitioned and loaded with the operating system and perhaps other software. Conventional OS (Operating System) includes a FDISK utility to prepare and partition a brand new hard disk. FDISK is used for formatting the hard disk to hold data and to logically partition the disk, specifying and naming major portions of it for different uses.

Hard disk repartitioning is one of the common tasks that people are facing when installing a second OS on their PC (personal computer). Each OS uses their own file systems. For example, Windows XP primarily uses NTFS and can use FAT32. Linux should be installed on their own file system Ext3 or Reisner. In this case users of the computer system need at least two additional partitions. If the NTFS system encompasses the whole hard disk repartitioning is the best option. The second important use of repartitioning is to create a partition to backup bootable partition.

In addition to setting up a new hard disk drive, FDISK is used for repartitioning the hard disk when the users want to change something. For example, a computer can be set up as a dual boot system, with one operating system (for example, Windows 2000) in one partition and another operating system (for example, Linux) in another partition. Disk partitioning is also commonly used on LAN servers, where different sets of users share different files and applications.

FDISK has its limitations. The users can't move applications from one partition to another without uninstalling and reinstalling the software. FDISK erases all data on the hard disk. When repartitioning the hard disk that contains data, repartitioning will wipes out all data on the disk. The users need to back up all data to another storage medium first. And the users can't delete or create new partitions without going through the entire FDISK and formatting process again.

FIG. 1 illustrates statuses of a hard disk. At status 1, partition 3 is under minimizing in size. At status 2, partition 3 is deleted by the conventional FDISK. At status 3, partition 3 is created to custom fit the size of the new partition. Data in the previous partition 3 is lost accordingly.

However, special partitioning software such as Partition Magic can be used instead of FDISK. Partitioning software allows the users to create, delete, and resize partitions. The users can move applications from one partition to another without uninstalling and reinstalling the application. The users can hide partitions to protect data from other users.

FIG. 2 illustrates statuses of a partition located on the hard disk. The partition contains a file system FAT. At status 1, the partition is under size minimizing. At status 2, FAT table and data area are resized by the conventional Partition Magic. However, since the FAT table needs to be resized, data in the partition is easy to be lost.

Meanwhile, most real-time operating systems employ preemptive schedulers. Preemptive multitasking differs from non-preemptive multitasking in that the operating system can take control of the processor without the task's cooperation. The process of a task having control taken from it is called preemption. Windows NT uses preemptive multitasking for all processes except 16-bit Windows 3.1 programs. If tasks are coming into conflict, data in the partition will probably be lost.

### SUMMARY OF THE INVENTION

The present invention provides a method for resizing partition to resolve the foregoing problems faced by the conventional techniques. The present invention also has the advantage of providing a high protective capacity to the data in the partition.

An object of the present invention is to provide a method of resizing partition, wherein a MBR is replaced. This makes the method easy to be manipulated.

Another object of the present invention is to provide a method of resizing partition, which can avoid losing user data or damaging system integrity.

In accordance with an aspect of the present invention, a method of resizing a partition, suitable for a computer system, the method comprising the steps of: calculating data in the partition to be modified; replacing a MBR with a new MBR; loading the new MBR; and changing data in accordance with the calculated data.

In the preferred embodiment of the invention, the data to be modified comprises BPB (Bios Parameter Block) of the partition. The BPB is changed under real mode. Length of a FAT table is unchanged. The method further comprises the step of recording length of the partition, replacing the new MBR with the MBR, rebooting the computer system, loading the MBR and defragmenting disk of the computer system.

In accordance with another aspect of the present invention, another method of recovering a resized partition, suitable for a computer system, the method comprising the steps of: replacing a MBR with a new MBR; loading the new MBR; and changing data in accordance with an original length of the partition.

In the preferred embodiment of the invention, the changed data comprises BPB (Bios Parameter Block) of the resized partition. The BPB is changed under real mode. Length of a FAT table is unchanged. The method further comprises the step of replacing the new MBR with the MBR, rebooting the computer system and loading the MBR.

The present invention may best be understood through the following description with reference to the accompanying drawings, in which:

### BRIEF DESCRIPTION OF THE DRAWINGS

FIG. 1 is a diagram illustrating a hard disk which implements the conventional FDISK;

FIG. 2 is a diagram illustrating a partition which implements the conventional Partition Magic;

FIG. 3 is a flowchart illustrating a method of the present invention;

FIG. 4 is a flowchart further illustrating the method shown in FIG. 3; and

FIG. 5 is diagram illustrating a partition which implements the method of the present invention.

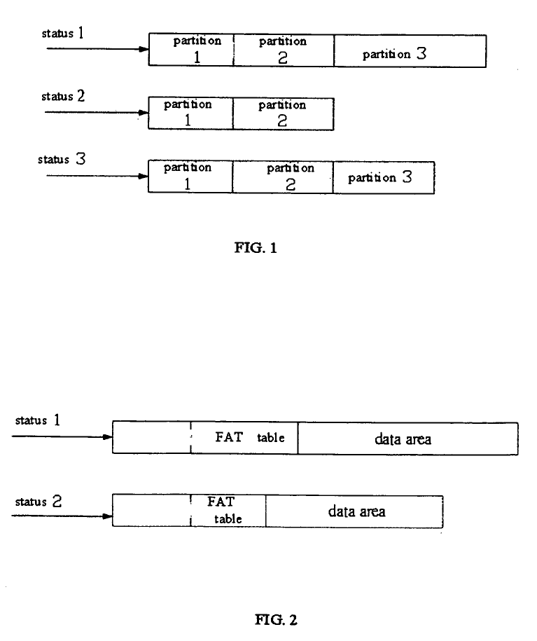

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purpose of illustration and description only. It is not intended to be exhaustive or to be limited to the precise form disclosed.

The present invention describes a method of resizing a partition to replacing a MBR with a new MBR, which can adjust size of the partition. Moreover, the data in the partition can be secured.

According to the preferred embodiment of the present invention, a method of resizing a partition, suitable for a computer system, the method comprising the steps of: calculating data in the partition to be modified; replacing a MBR with a new MBR; loading the new MBR; and changing data in accordance with the calculated data.

Data to be modified comprises BPB (Bios Parameter Block) of the partition. The BPB is changed under real mode. Length of a FAT table is unchanged. The method further comprises the step of recording length of the partition, replacing the new MBR with the MBR, rebooting the computer system, loading the MBR and defragmenting disk of the computer system.

According to the preferred embodiment of the present invention, there is another method of recovering a resized partition, which is suitable for a computer system. The method comprises the steps of: replacing a MBR with a new MBR; loading the new MBR; and changing data in accordance with an original length of the partition.

Changed data comprises BPB (Bios Parameter Block) of the resized partition. The BPB is changed under real mode. Length of a FAT table is unchanged. The method further comprises the step of replacing the new MBR with the MBR, rebooting the computer system and loading the MBR.

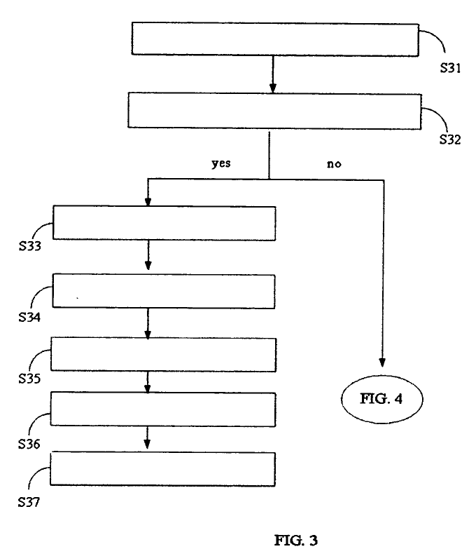

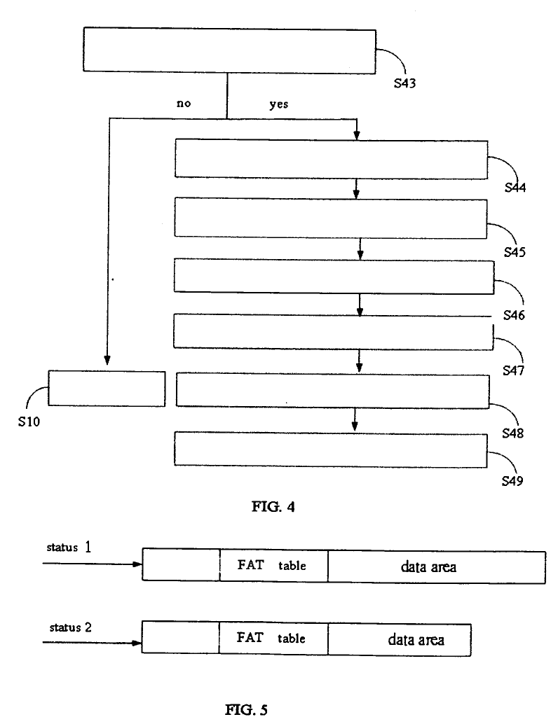

Referring to FIG. 3, a flowchart illustrating a method of the present invention is shown. The method of resizing a partition is suitable for a computer system. In step S31, the user selects a partition located on the hard disk. The partition contains a plurality of sectors. In step S32, the computer system checks space of continuous unused sectors at the bottom of the selected partition. If the free space satisfied the requirement, then the computer system continues at step S33, else the system continues to FIG. 4.

In step S33, the computer system calculates data in the partition to be modified, such as BPB (Bios Parameter Block) and partition chain. Also, length of the partition can be recorded, in order to recover the resized partition in the future. In step S34, the computer system replaces a new MBR. In step S35, the computer system is rebooted. The new MBR is loaded and run.

In step S36, the computer system changes the to-be-modified data in accordance with the calculated data. The BPB (Bios Parameter Block) and the partition chain may be modified under real mode. Thus the partition is minimized. Meanwhile, length of a FAT table is unchanged, in order to easily recover the resized partition in the future.

In step S37, the computer system may replace the new MBR with the previous MBR. After that, the computer system may be rebooted. Otherwise, the computer system may load and run the previous MBR. The previous MBR may load the OS of the computer system.

Referring to FIG. 4, a flowchart illustrating the method shown in FIG. 3 is shown. In step S43, the computer system checks space of entire unused sectors of the selected partition. If the free space satisfied the requirement, then the computer system continues at step S44, else the system continues at step S10 to end this operation.

In step S44, the computer system calculates data in the partition to be modified, such as BPB (Bios Parameter Block) and partition chain. Also, length of the partition can be recorded, in order to recover the resized partition in the future. In step S45, the computer system performs a disk defragmenting operation.

In step S46, the computer system replaces a new MBR. In step S47, the computer system is rebooted. The new MBR is loaded and run.

In step S48, the computer system changes the to-be-modified data in accordance with the calculated data. The BPB (Bios Parameter Block) and the partition chain may be modified under real mode. Thus the partition is minimized. Meanwhile, length of a FAT table is unchanged, in order to easily recover the resized partition in the future.

In step S49, the computer system may replace the new MBR with the previous MBR. After that, the computer system may be rebooted. Otherwise, the computer system may load and run the previous MBR. The previous MBR may load the OS of the computer system.

FIG. 5 illustrates a partition which implements the method of the present invention. The partition contains a file system FAT. At status 1, the partition is under size minimizing. At status 2, data area is resized and the number of sectors contained in the partition is less. While the length of the FAT table is unchanged, data in the partition is secured.

The present invention replaces MBR to resize partition, so that the method can easily to be manipulated. The present invention also ensures the data in the partition won't be destroyed due to the FAT table is not changed. Furthermore, the shortcoming that the partition cannot be restored to a previous state efficiently can be entirely avoided.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method of resizing a partition, suitable for a computer system, said method comprising the steps of:
calculating data in said partition to be modified;
replacing a MBR with a new MBR;
loading said new MBR; and
changing data in accordance with said calculated data.

2. The method according to claim 1, wherein data to be modified comprises BPB (Bios Parameter Block) of said partition.

3. The method according to claim 2, wherein length of a FAT table is unchanged.

4. The method according to claim 2, wherein said BPB is changed under real mode.

5. The method according to claim 1, further comprising the step of recording length of said partition.

6. The method according to claim 1, further comprising the step of replacing said new MBR with said MBR.

7. The method according to claim 6, further comprising the step of loading said MBR.

8. The method according to claim 7, further comprising the step of rebooting said computer system.

9. The method according to claim 7, further comprising the step of defragmenting.

10. A method of recovering a resized partition, suitable for a computer system, said method comprising the steps of:
replacing a MBR with a new MBR;
loading said new MBR; and
changing data in accordance with an original length of said partition.

11. The method according to claim 10, wherein changed data comprises BPB (Bios Parameter Block) of said resized partition.

12. The method according to claim 11, wherein length of a FAT table is unchanged.

13. The method according to claim 11, wherein said BPB is changed under real mode.

14. The method according to claim 10, further comprising the step of replacing said new MBR with said MBR.

15. The method according to claim 14, further comprising the step of loading said MBR.

16. The method according to claim 15, further comprising the step of rebooting said computer system.
